(19) United States
(12) Patent Application Publication
(10) Pub. No.: US 2025/0254054 A1
(43) Pub. Date: Aug. 7, 2025

(54) GROUP COMMUNICATIONS SYSTEM AND METHOD

(71) Applicant: Haedenbridge Co., Ltd., Seoul (KR)

(72) Inventor: Hwansik NAMGUNG, Seoul (KR)

(73) Assignee: Haedenbridge Co., Ltd., Seoul (KR)

(21) Appl. No.: 18/433,081

(22) Filed: Feb. 5, 2024

(51) Int. Cl. H04L 12/18; G06F 3/0481

(52) U.S. Cl. CPC H04L 12/1813; G06F 3/0481

(57) ABSTRACT

Provided is a video conference support method which includes: presenting a plurality of virtual space background objects, each of which is associated with seat arrangement and metadata representing seat information including a seat size, a seat level, and seat location coordinates for each seat, to a host terminal device through a network, and receiving information on a selected virtual space background object from the host terminal device; obtaining participant images each from the multiple terminal devices; constructing a composite image by arranging all the participant images on the selected virtual space background object according to the metadata and in a predetermined participant arrangement order; and encoding the selected virtual space background object constituting the composite image, and the participant images and audio, transmitting encoded data to the plurality of terminal devices, and causing the terminal devices to overlay and output the participant images on the selected virtual space background object.

### BACKGROUND

### 1. Field of the Invention

The present invention relates to a group communication system and method, and more particularly, to a group communication system and method for implementing a high-immersion video conference.

### 2. Discussion of Related Art

Multi-party video conferencing systems on Internet Protocol (IP) networks are largely implemented in two methods. The first method is a selective forwarding unit (SFU) method, that is, a method in which user terminals connecting a conference room each transmits images of the participants and a server switches the images in a corresponding conference room session and relays the images. The second method is a multipoint control unit (MCU) method, and is a method in which a server composites images each received from user terminals connecting a conference room and transmits the composite images to each of the users connected to the conference room. Regardless of which of the above implementation methods is adopted, in the conventional multi-party video conference system, a user interface in which images of terminals connected to a video conference session are arranged in a grid type has been maintained for decades.

Recently, methods in which, by removing the background from images of conference participants and placing the result image on top of a virtual space image, the conferences concentration is increased through the sense of presence caused by the same virtual space image have been introduced. However, in conventional group communication, image arrangement in a virtual space is nothing more than simply placing images of participants with their backgrounds removed on top of a virtual space image, and there is a limit in providing highly immersive two-way communication. Moreover, conventionally, images of participants are arranged sequentially or randomly according to the order of entry, regardless of the composition of the virtual space image. Accordingly, it can be said that there is virtually no effect in enhancing the sense of presence, and artificial screen rearrangement work is often required.

For example, when the virtual space is formed to have the same shape as a conference room in the real world, it is necessary to express seats in perspective by making the rear seat or desk smaller than the front seat or desk and also adjust the perspective of the participant image, in order to generate a three-dimensional virtual space. However, in conventional systems, such perspective representation is not implemented, and, accordingly, the sense of presence and immersion is not significantly increased.

Meanwhile, even in a video conference room, just like in the real world, protocol may be important, and seating arrangements that takes into account the social status of specific participants, such as very important persons (VIPs), may be necessary. However, in conventional systems, since participants are listed in the order of their entrance, it is difficult to consider protocol and it is difficult to highlight the importance of speech, amount of speech, and movement of specific participants in a conference. There are systems that allow a conference room opener or host to manually rearrange an image size or order of participants in a virtual space. However, when the conference room is large and the number of participants is large, a time required for these manual settings may be very long, and it is difficult to immediately reflect changes in circumstances.

### SUMMARY OF THE INVENTION

The present invention is directed to providing a group communication system and method that can immediately start a high-immersion video conference based on a virtual space background by automatically adjusting seat coordinates, seat characteristics, and seat size for optimized participant image arrangement according to the composition of the virtual space background object in a video conferencing system.

The present invention is also directed to providing a group communication system and method for more realistic and high-immersion video conferences, including an event sharing function, through viewer control of images beyond simple images as well as various virtual space background objects such as web pages, screen sharing, videos, second cameras, and the like, as a virtual space background to increase immersion.

According to an aspect of the present invention, there is provided a video conference support method which is performed by a group communication server to which multiple participants are able to be connected using their own terminal devices. The video conference support method includes: presenting a plurality of virtual space background objects, each of which is associated with seat arrangement and metadata representing seat information including a seat size, a seat level, and seat location coordinates for each seat, to a host terminal device through a network, and receiving information on a selected virtual space background object from the host terminal device; obtaining participant images each from the multiple terminal devices; constructing a composite image by arranging all the participant images on the selected virtual space background object according to the metadata and in a predetermined participant arrangement order; and encoding the selected virtual space background object constituting the composite image, and the participant images and audio, transmitting encoded data to the plurality of terminal devices, and causing the terminal devices to overlay and output the participant images on the selected virtual space background object.

The video conference support method may further include, before performing the presenting of the plurality of virtual space background objects to the host terminal device through the network and the receiving of the information on the selected virtual space background object from the host terminal device, receiving a request to proceed with a high-immersion conference mode from a predetermined conference host terminal device.

The video conference support method may further include receiving and determining the participant arrangement order from the conference host terminal device after receiving the request to proceed with the high-immersion conference mode.

In the encoding of the selected virtual space background object, the participant images, and the audio and the transmitting of the encoded data to the plurality of terminal devices, the selected virtual space background object, the participant images, and the audio may be individually encoded and the encoded data may be transmitted to the plurality of terminal devices.

Each of the plurality of virtual space background objects may include a plurality of seats where a seat size and a displayable user image size are determined differently in perspective.

The selected virtual space background object may include an event element that is able to selectively cause a state change. In this case, the encoding of the selected virtual space background object, the participant images and the audio and the transmitting of the encoded data to the plurality of terminal devices may include transmitting the content of the state change of the event element to the plurality of terminal devices so that the terminal devices reflect the state change of the event element on the selected virtual space background object.

According to another aspect of the present invention, there is provided a group communication support device that allows multiple participants to conduct a video conference using their own terminal devices. The group communication support device includes a memory configured to store program instructions, and a processor that is connected to the memory and executes the program instructions stored in the memory. When the program instructions are executed by the processor, the program instructions allow the processor to: present a plurality of virtual space background objects, each of which is associated with seat arrangement and metadata representing seat information including a seat size, a seat level, and seat location coordinates for each seat, to a host terminal device through a network, and receive information on a selected virtual space background object from the host terminal device; obtain participant images each from the plurality of terminal devices; construct a composite image by arranging all the participant images on the selected virtual space background object according to the metadata and in a predetermined participant arrangement order; and encode the selected virtual space background object constituting the composite image, and the participant images and audio, transmit encoded data to the plurality of terminal devices, and cause the terminal devices to overlay and output the participant images on the selected virtual space background object.

The program instructions may include instructions for causing the processor to receive a request to proceed with a high-immersion conference mode from a predetermined conference host terminal device before presenting the plurality of virtual space background objects to the host terminal device through the network.

The program instructions may additionally include instructions for causing the processor to perform an operation of receiving and determining the participant arrangement order from the conference host terminal device after receiving the request to proceed with the high-immersion conference mode.

The program instructions may cause the processor to individually encode the selected virtual space background object, the participant images, and the audio and transmit the encoded data to the plurality of terminal devices.

Each of the plurality of virtual space background objects may include a plurality of seats where a seat size and a displayable user image size are determined differently in perspective.

The selected virtual space background object may include an event element that is able to selectively cause a state change. In this case, the program instructions for causing the processor to encode the selected virtual space background object, the participant images and the audio and transmit the encoded data to the plurality of terminal devices may include instructions for transmitting the content of the state change of the event element to the plurality of terminal devices so that the terminal devices reflect the state change of the event element on the selected virtual space background object.

According to still another aspect of the present invention, there is provided a method for a conference host terminal device to set and execute a video conference conducted by a group communication server to which multiple participants are able to be connected using their own terminal devices. The video conference setting and executing includes: transmitting a request to proceed with a high-immersion conference mode to the group communication server; receiving a plurality of virtual space background objects, each of which is associated with seat arrangement and metadata representing seat information including a seat size, a seat level, and seat location coordinates for each seat, from the group communication server through a network, and transmitting information on a virtual space background object selected by a host; obtaining and encoding an image and audio of the participant from the conference host terminal device using a camera and microphone and transmitting the encoded images and audio to the group communication server; receiving the selected virtual space background object, multiple participant images, and composite audio from the group communication server; and overlaying and outputting the participant images on the selected virtual space background object along with audio output.

The receiving of the selected virtual space background object, the multiple participant images, and composite audio from the group communication server or the overlaying and outputting of the participant images on the selected virtual space background object may include reflecting the state change of the event element that is able to selectively cause a state change in the selected virtual space background object on the selected virtual space background object.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a configuration and network environment of a group communication system according to an embodiment of the present invention;

FIG. 2 is a block diagram illustrating a media processing server according to an embodiment of the present invention;

FIG. 3 is a block diagram of an embodiment of a video conference program loaded and executed on terminal devices;

FIG. 4 is a flowchart illustrating an overall group communication process of the video conference server system illustrated in FIG. 1;

FIG. 5 is a flowchart illustrating a high-immersion conference mode setting process;

FIGS. 6A to 6D are screenshots showing examples of virtual space background object selection screens;

FIG. 7 is a flowchart illustrating an embodiment of a process in which a high-immersion conference mode video conference is executed;

FIG. 8 is a flowchart illustrating an embodiment of a process in which an event is processed; and

FIGS. 9A to 9H are screenshots of video conference images generated by overlaying participant images on a virtual space background object.

### DETAILED DESCRIPTION OF EXEMPLARY EMBODIMENTS

While the present invention is open to various modifications and alternative forms, specific embodiments thereof are shown by way of example in the drawings and will herein be described in detail. However, it should be understood that there is no intent to limit the present invention to the particular forms disclosed, and on the contrary, the present invention is to cover all modifications, equivalents, and alternatives falling within the spirit and scope of the present invention. Like numbers refer to like elements throughout the description of the figures.

It should be understood that, although the terms “first,” “second,” and the like may be used herein to describe various elements, the elements are not limited by the terms. The terms are only used to distinguish one element from another element. For example, a first element could be termed a second element, and, similarly, a second element could be termed a first element without departing from the scope of the present invention. As used herein, the term “and/or” includes any and all combinations of one or more of the associated listed items.

It should be understood that when an element is referred to as being “connected” or “coupled” to another element, the element may be directly connected or coupled to another element or intervening elements may be present. In contrast, when an element is referred to as being “directly connected” or “directly coupled” to another element, there are no intervening elements present.

It will be understood that the terminology used herein is for the purpose of describing particular embodiments only and is not intended to be limiting to the present invention. As used herein, the singular forms “a” and “an” are intended to include the plural forms as well, unless the context clearly indicates otherwise. It will be further understood that the terms “comprise,” “comprising,” “include,” and/or “including,” when used herein, specify the presence of stated features, integers, steps, operations, elements, and/or components but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the present invention belongs. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

Hereinafter, exemplary embodiments of the present invention will be described in detail with reference to the accompanying drawings. In the description of the invention, in order to facilitate overall understanding, like reference numerals in the drawings denote like elements, and thus the description thereof will not be repeated.

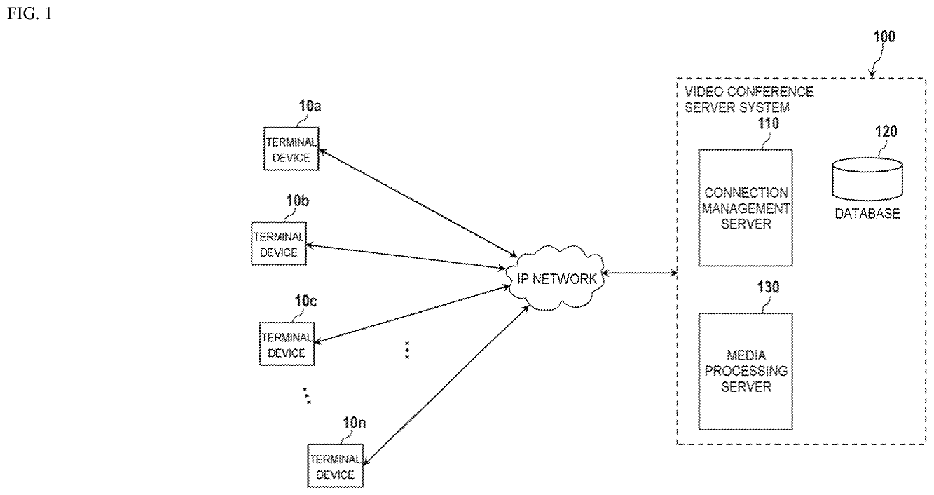

FIG. 1 is a block diagram illustrating a configuration and network environment of a group communication system according to an embodiment of the present invention. The group communication system of FIG. 1 is implemented with a video conference server system 100 that provides a high-immersion video conference service to a plurality of terminal devices 10a to 10n through Internet Protocol (IP) networks. The video conference server system 100 may include a connection management server 110, a database 120, and at least one media processing server 130. Although not illustrated in the drawing, the video conference server system 100 may additionally include a plurality of data transmission servers dedicated to data transmission between the terminal devices and the media processing server to smoothly perform connection support and service provision for the plurality of terminal devices 10a to 10n.

The connection management server 110 is a server to which the terminal devices 10a to 10n that are intended to open a video conference or participate in the video conference are connected first, and may be implemented based on a web server. The connection management server 110 performs login processing, including user authentication, on terminal devices that are intended to receive video conference services. Further, the connection management server 110 may receive a request to perform tasks such as opening, participating in, deleting, or changing a session (i.e., conference) from the terminal devices 10a to 10n and perform the requested task. The connection management server 110 may generate a session code for each session generated or reserved and store the session code in the database 120.

Further, the connection management server 110 may set resources for each session generated or reserved. The resources for each session may include at least some of video conference parameter values, such as resolutions of a conference room background virtual space image and participant image, frames per second, a bandwidth, a maximum number of connected users, a maximum number of images, etc. The sessions may be scheduled to be generated at a specific time point, or may be generated immediately. Meanwhile, when a plurality of media processing servers 130 are present in the system, the connection management server 110 may refer to real-time performance index information of each media processing server 130 that is stored in the database 120 to allocate one of a plurality of media processing devices to the terminal devices 10a to 10n requesting session opening.

System setting data such as user data, data for conference room generation and reservation, resources for each session, and the like are stored in the database 120. Further, when a plurality of media processing servers 130 are present in the system, real-time performance index information of each media processing server 130 may be stored in the database 120. The performance index information may include at least some of central processing unit (CPU) usage, memory capability, and network bandwidth usage. The database 120 is linked to the connection management server 110 and may provide data requested by the connection management server 110 to the connection management server 110.

The media processing server 130 may open a conference room by generating a session object according to a request from the terminal device (e.g., 10a) of a user of a terminal device (hereinafter referred to as an “opener”) who has applied for opening the conference room. The media processing server 130 may open a conference room by generating a session object at a certain time even for a session reserved for opening. The media processing server 130 may set a high-immersion conference mode for the conference room according to a request from a host terminal device 10a. The media processing server 130 allows the host terminal device to select a virtual space background object and an event for a session in which the high-immersion conference mode is set. The host is a person who has opened the conference, a user to whom the conference opener has granted the right to proceed, or a person who has obtained the right to proceed through other processes. The media processing server 130 performs encoding, decoding, and distribution of virtual space background object images, participant images, and audio for each session. Meanwhile, the media processing server 130 may periodically or aperiodically store its own performance index information in the database 120.

The media processing server 130 may maintain a session participating terminal list and a stream type list for each session object therein or in the database 120. The session participating terminal list includes a list of the terminal devices 10a to 10n participating in the session. The stream type list indicates terminal performance or quality conditions for transmission/reception images according to the terminal type. Here, the terminal type may be divided into, for example, a low-end personal computer (PC), a high-end PC, a dual display, a smartphone, etc. Meanwhile, the quality conditions for transmission/reception images may be, for example, reception resolution and frames per second. The reason for distinguishing stream types and registering and maintaining the stream type for each terminal device is to provide a media stream of optimal quality to each terminal device being connected to the session. The media processing server 130 may update the session participating terminal list and the stream type list for each session whenever the participant terminal devices are connected or disconnected.

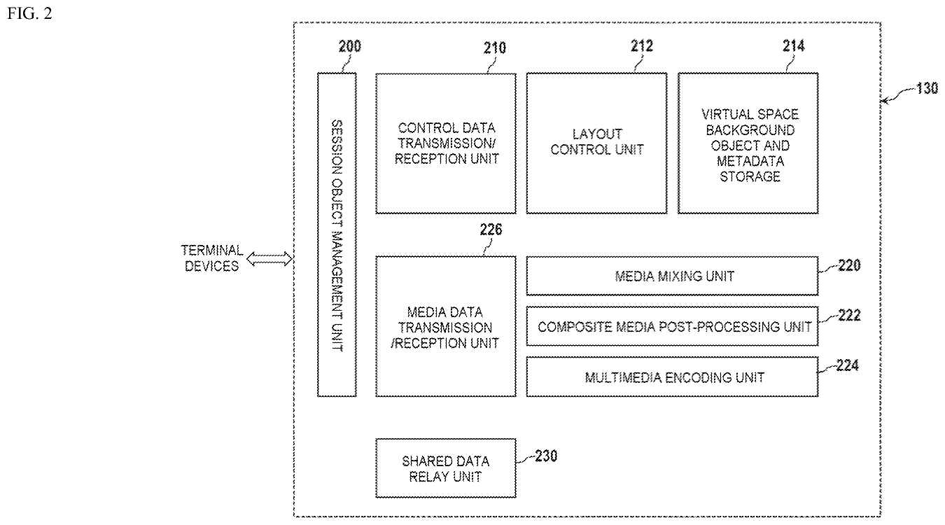

FIG. 2 is a block diagram illustrating a media processing server 130 according to an embodiment of the present invention. In the illustrated embodiment, the media processing server 130 includes a session object management unit 200, a control data transmission/reception unit 210, a layout control unit 212, a virtual space background object and metadata storage 214, a media mixing unit 220, a composite media post-processing unit 222, a multimedia encoding unit 224, a media data transmission/reception unit 226, and a shared data relay unit 230.

The session object management unit 200 generates a session object when a session is established, and manages list information and stream type information of terminal devices participating in the session until the session is terminated. The control data transmission/reception unit 210 may transmit control data for terminal devices 10a to 10n and receive status information of the terminal devices 10a to 10n.

The layout control unit 212 arranges participant images received from the terminal devices 10a to 10n, according to metadata mapped to a virtual space background object and in the order of participant arrangement set by a conference room opener when a conference room is reserved, and maintains and manages the arrangement regardless of the participants entering and leaving the conference room.

In the virtual space background object and metadata storage 214, metadata such as a plurality of virtual space background objects, the number and arrangement of seats for each virtual space background object, a seat index for each seat, a seat size (i.e., participant image size), a seat level, and seat location coordinates may be stored.

The media mixing unit 220 may construct a composite image combining the virtual space background objects and the participant images according to the arrangement. The composite media post-processing unit 222 may individually encode image elements constituting the composite image, that is, virtual space background objects, participant images, and audio, and format the image elements according to a predetermined frame structure. The multimedia encoding unit 224 may encode media with separate quality for each stream type in the stream type list so that each of the terminal devices 10a to 10n can receive an optimal media stream. The media data transmission/reception unit 226 receives the corresponding participant image and audio in an encoded form from each of the terminal devices 10a to 10n and transmits a media stream for the composite image to the terminal devices 10a to 10n.

The shared data relay unit 230 transmits an event related to the virtual space background object to all the terminal devices 10a to 10n in response to an activation command from the host terminal device 10n, and allows the same event effect to be shared between the terminal devices 10a to 10n.

The media processing server 130 described above may be implemented with a computing device including at least one processor, a memory, and a storage device.

The processor may execute program instructions stored in the memory and/or storage device. The processor includes at least one CPU or graphics processing unit (GPU), and may be implemented with any other processor capable of performing the method according to the present invention. The memory may include, for example, a non-volatile memory such as a read-only memory (ROM) and a volatile memory such as a random access memory (RAM). The memory may load program instructions stored in the storage device and provide the program instructions to the processor.

The storage device is a recording medium suitable for storing program instructions and data, and includes, for example, a magnetic medium such as a hard disk, a floppy disk, and magnetic tape, an optical medium such as a compact disk read-only memory (CD-ROM) and a digital video disk (DVD), a magneto-optical medium such as a floptical disk, and a semiconductor memory such as a flash memory, an erasable programmable ROM (EPROM), or SSE manufactured based on them. In the storage device, program instructions, databases, and other data according to the present invention are stored. The program instructions described above may be loaded onto the memory under the control of the processor, and executed by the processor to implement the method according to the present invention.

Meanwhile, as the terminal devices 10a to 10n, for example, a desktop PC, a laptop PC, a tablet PC, a smartphone, etc., may be used, but the present invention is not limited thereto, and various other devices may be used as the terminal devices. Each of the terminal devices 10a to 10n may include at least one processor, a memory, and a storage device, and may load and execute a video conference program.

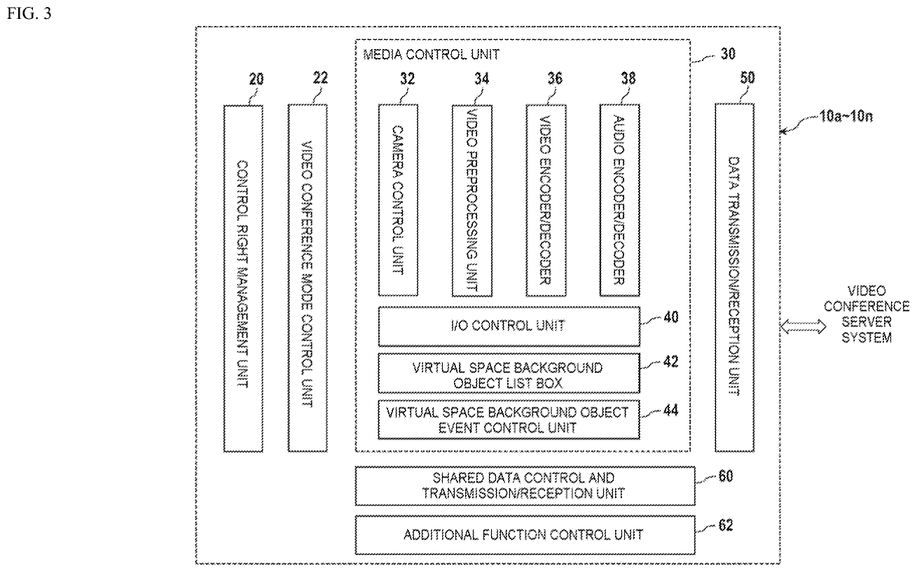

FIG. 3 is a block diagram of an embodiment of a video conference program loaded and executed on terminal devices 10a to 10n. In the illustrated embodiment, each of the terminal devices 10a to 10n includes a control right management unit 20, a video conference mode control unit 22, a media control unit 30, an inputting/outputting (I/O) control unit 40, a virtual space background object list box 42, a virtual space background object event control unit 44, a data transmission/reception unit 50, a shared data control and transmission/reception unit 60, and an additional function control unit 62.

The control right management unit 20 may determine and change a subject authorized to change settings for each session. The authority to change settings for a session initially belongs to a person who has opened a corresponding session. However, the conference opener may separately designate a host, and in this case, the opener and/or the host has the authority to change the settings. People with the authority to change settings may be changed or added by other methods. The video conference mode control unit 22 may select or change one of a high-immersion conference mode or a general conference mode as a video conference operation mode depending on the host's selection.

In the media control unit 30, a camera control unit 32 controls a camera to capture videos of conference participants. A video preprocessing unit 34 replaces a background with a random color in the videos of the conference participants captured by the camera and adjusts an image size to be matched with a predetermined size. A video encoder/decoder 36 encodes the resized videos of the conference participants to be transmitted to the media processing server 130 and decodes the encoded videos of the participants received through the media processing server 130. An audio encoder/decoder 38 encodes audio of the conference participants to be transmitted to the media processing server 130 and decodes the encoded audio of the participants received through the media processing server 130. The I/O control unit 40 controls the output of the virtual space background object and the video and audio of each conference participant that are received from the media processing server 130. In particular, the I/O control unit 40 overlays the virtual space background object and the videos of the participants so that the videos of the participants are output in a composite form with the virtual space background object.

The virtual space background object list box 42 may allow the virtual space background object to be constructed and edited as a list box, which is a list that forms a selection screen. The virtual space background object event control unit 44 may overlay an event effect on the virtual space background object so that the content of the corresponding event can be displayed according to the event content information received through the media processing server 130.

The data transmission/reception unit 50 transmits media data including the encoded video data and the encoded audio data to the media processing server 130 and receives the virtual space background object and media data for other participants from the media processing server 130.

When the selected virtual space background object has a component that can cause an event, the shared data control and transmission/reception unit 60 may transmit event content information to the media processing server 130 when the host terminal device 10n activates the event. Further, the shared data control and transmission/reception unit 60 may transmit shared data to be shared by participants to the media processing server 130 and receive shared data provided by other terminal devices through the media processing server 130. The additional function control unit 62 may control the setting and performance of other additional functions.

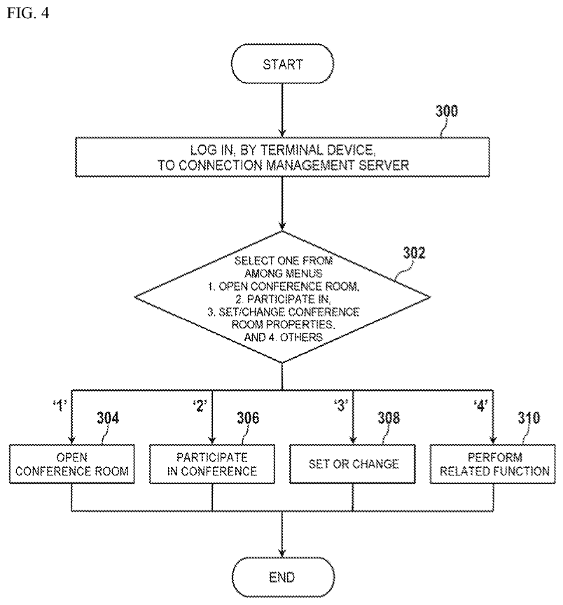

Hereinafter, the operation of the group communication system illustrated in FIG. 1 will be described with reference to FIGS. 4 to 8.

FIG. 4 is a flowchart illustrating an overall group communication process of the video conference server system illustrated in FIG. 1. The terminal devices 10a to 10n that want to receive the video conference service log in to the connection management server 110 of the video conference server system 100 (operation 300). The connection management server 110 may allow access to the service after performing user authentication for the terminal devices 10a to 10n that want to log in.

After the access to the service is permitted, the terminal devices 10a to 10n may select any one from among menus “open conference room,” “participate in conference,” “set/change conference room properties,” and “others” (operation 302). After the terminal devices 10a to 10n selects the menu, the corresponding terminal device may be connected to the media processing server 130, and the media processing server 130 may perform an operation according to the selection of the terminal device. When a plurality of media processing servers 130 are present in the video conference server system 100, the connection management server 110 may select the media processing server most appropriate for the menu selected by the terminal devices 10a to 10n on the basis of a real-time performance index of each media server 130 stored in the database 120, and transmit information on the selected media processing server 130 to the terminal device so that the terminal device can access the corresponding media processing server 130. In a modified embodiment, the performance index of the media processing servers 130 is not stored in the database 120, and the connection management server 110 may query the performance indexes from the media processing servers 130 and select one of the performance indexes. The connection management server 110 may randomly select any one of the plurality of media processing servers.

Meanwhile, the terminal device may make a selection corresponding to operation 302 before logging in, in operation 300. In this case, immediately after logging in to the corresponding terminal is completed, the media processing server 130 may perform an operation according to the selection of the terminal device without requiring additional selection by the terminal device.

In operation 302, when the terminal device 10a selects the menu “open conference room,” the connection management server 110 may set conference room properties according to the selection of the user of the terminal device that applied for opening the conference room (hereinafter, referred to as an “opener”), and reserve the conference room or immediately open the conference room (operation 304). Hereinafter, for convenience of description, it is assumed that the terminal device 10a among the terminal devices 10a to 10n is an opener terminal device. The conference room properties may include at least some of a conference schedule, a conference room video resolution, conference invitees, the number of seats, and seat ratings. When the opener has finished reserving the conference room and setting the conference room properties, the connection management server 110 may generate and store identification information of the conference room, such as a conference room invitation uniform resource locator (URL) or session code, and transmit the identification information to the terminal devices 10b to 10n of conference invitees (operation 306).

In operation 302, when the terminal devices 10a to 10n select the menu “participate in conference,” the connection management server 110 confirms the identification information of the conference room in which the terminal devices 10a to 10n want to participate, and then allows the terminal devices 10a to 10n to participate in the conference room (operation 308). Participation in a conference may be accomplished by the terminal devices 10a to 10n presenting the identification information of the conference room such as a session code to the connection management server 110. Meanwhile, participation in a conference may be accomplished through the conference room invitation URL that the terminal devices 10b to 10n receive from the opener terminal device 10a. In this case, when the terminal devices 10b to 10n are connected to the web server or the connection management server 110 using the conference room URL and then complete a login procedure, the terminal devices 10b to 10n may enter the conference room corresponding to the invitation URL. On the other hand, participation in a conference may be accomplished by the terminal devices 10b to 10n permitted to access to the service selecting a random conference session. In this case, the connection management server 110 may transmit an appropriate session code of the media processing server 130 to the terminal devices 10b to 10n, and the terminal devices 10b to 10n may present the session code to the media processing server 130 to enter the conference room.

Meanwhile, in operation 302, when the terminal device 10a selects the menu “set/change conference room properties,” the connection management server 110 may allow the terminal device 10a to select or change the conference room properties or cancel the conference in a similar manner to operation 304 or 306. In operation 302, when the terminal devices 10a to 10n selects the menu “others,” the connection management server 110 may perform an operation corresponding to the selection of the terminal device.

In an exemplary embodiment, when the opener terminal device 10a opens a conference room, the media processing server 130 may read detailed session information related to the conference room from the database 120, generate a session object, and store information on the session object in the database 120. In the case of a reserved session, the session object may be generated a certain amount of time before the conference starts, or the session object may be generated upon entry of the first participant. In this case, the media processing server 130 may check whether a session object corresponding to the session code received from the terminal devices 10a to 10n is present, and when the corresponding session object has not been generated, the media processing server 130 may generate a session object, or when the corresponding session object has been already generated, the media processing server 130 may update information on the terminal device in the session object.

For example, when the terminal devices 10a to 10n of the first participant are connected, the media processing server 130 may receive session code information from the terminal devices 10a to 10n, and read detailed session information corresponding to the session code from the database 120 to generate a session object appropriate for the detailed session information. Subsequently, the media processing server 130 may register information on the corresponding terminal devices 10a to 10n in a session participating terminal list. In this case, the media processing server 130 may also register the information on the terminal devices 10a to 10n in a stream type list indicating terminal performance or quality conditions for transmission/reception images according to a terminal type. The detailed session information may include the type of each terminal (e.g., low-end PC, high-end PC, dual display, smartphone, etc.) in the corresponding session, a stream type according to the terminal type, etc. The stream type indicates terminal performance or quality conditions for transmission/reception images according to the terminal type, and may be, for example, reception resolution or frames per second.

Whenever the terminal devices 10a to 10n that are invited using a conference invitation URL or other methods of inducing conference attendance are connected to the media processing server 130 in order to participate in the corresponding conference room, the media processing server 130 may update the session participating terminal list and the stream type list within the corresponding session object.

Among the terminal devices 10a to 10n connected to the media processing server 130, the terminal device (hereinafter, assumed to be 10n) used by the conference host may change the session settings before starting the session and/or during the session. The conference host may be a person who has opened the conference, a user to whom the conference opener has granted the right to proceed, or a person who has obtained the right to proceed through various other methods. In particular, according to the present invention, the host terminal device 10n may set an operation mode of the corresponding conference room to a high-immersion conference mode. When the high-immersion conference mode is not set and declared, the video conference is held in the corresponding conference room in a normal mode, that is, with participants displayed in a general grid format.

FIG. 5 is a flowchart illustrating a high-immersion conference mode setting process.

The media processing server 130 may provide an operation mode setting/changing screen to the host terminal device 10n (operation 400). In the provided settings screen, the host terminal device 10n may select a high-immersion conference mode. When the host selects the high-immersion conference mode (operation 402), a high-immersion conference execution request signal is transmitted from the host terminal device 10n to the media processing server 130 (operation 404). Subsequently, the media processing server 130 provides a screen on which various virtual space background objects can be selected to the host terminal device 10n (operation 406).

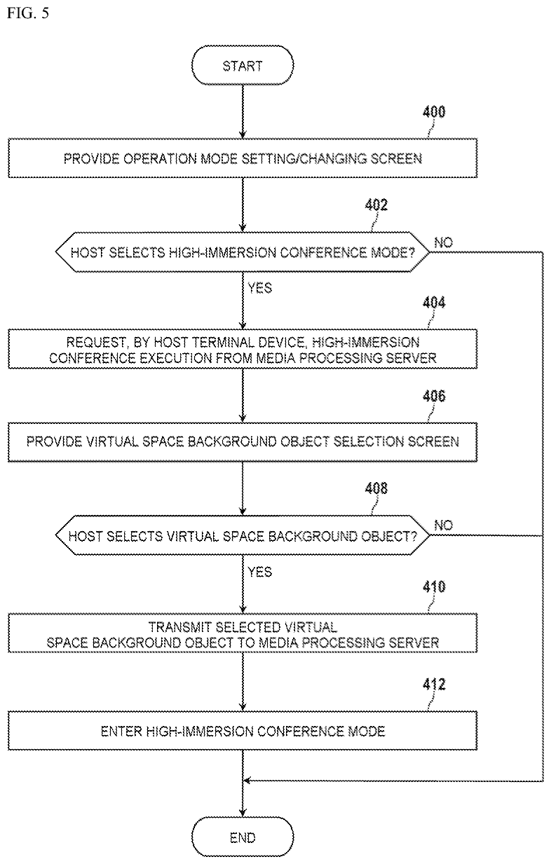

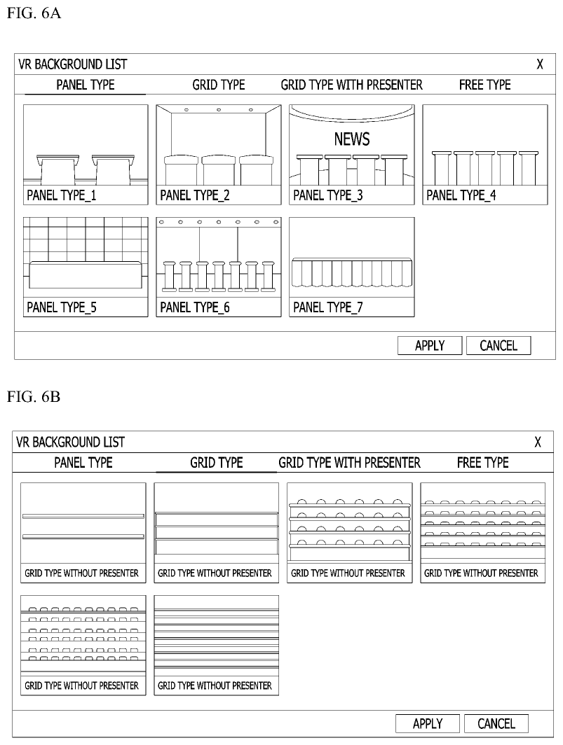

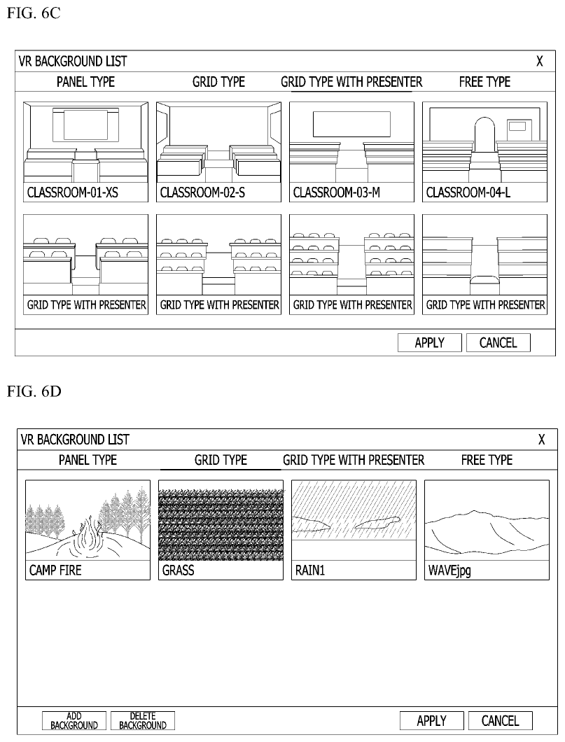

FIGS. 6A to 6D show examples of virtual space background object selection screens. As shown in the drawings, the virtual space background object selection screens may include multiple selectable virtual space background objects. The selectable virtual space background objects may include a panel-type background object, a grid-type background object without a presenter/host podium, a grid-type background object with a presenter/host podium, and other user-defined objects. In each of the virtual space background objects shown as in the examples of FIGS. 6A to 6D, metadata such as the number and arrangement of seats, a seat index for each seat, a seat size (i.e., participant image size), a seat level, seat location coordinates, and the like may be mapped or embedded. In each background object, the participant seats may be arranged to reflect perspective.

However, the present invention is not limited to using only the virtual space background objects to which metadata is mapped as described above, and simple images, web pages, videos, second camera images, etc., to which metadata is not mapped may also be used as virtual space background object content. In the following description, for convenience of description, an exemplary embodiment will be described focusing on high-immersion group communication using a virtual space background object to which metadata is mapped. The embodiment in which the virtual space background object content to which metadata is not mapped as described above is used is similar to the exemplary embodiment except for matters related to metadata processing. Since those skilled in the art to which the present invention pertains can easily implement the present invention on the basis of the present specification, a detailed description of the embodiments will be omitted.

Referring to FIG. 5 again, the host may select one from among the virtual space background objects through the host terminal device 10n. In operation 408, when the host terminal device 10 selects any one virtual space background object on the virtual space background object selection screen, information on the selected virtual space background object is transmitted from the host terminal device 10n to the media processing server 130 (operation 410).

When the media processing server 130 receives the information on the selected virtual space background object, the media processing server 130 transmits the seat size, that is, information on the participant image size, among the conference mode identification information indicating a high-immersion conference mode, the information on the selected virtual space background object, and the metadata mapped to the selected virtual space background object, to the terminal devices 10a to 10n connected to the corresponding session. In this case, the information on the selected virtual space background object transmitted to the terminal devices 10a to 10n may be the virtual space background object itself or an index value that allows identification of the corresponding object. When the index value is transmitted, the terminal devices 10a to 10n may select one virtual space background object on the basis of the index value received from a set of virtual space background objects stored in their own storage device or other storage.

In operation 412, all the terminal devices 10a to 10n recognize the execution of the high-immersion conference mode on the basis of the conference mode identification information and enters the high-immersion conference mode. However, in a modified embodiment, only terminal devices that meet certain conditions in terms of terminal performance or quality conditions for transmission/reception images may enter the high-immersion conference mode.

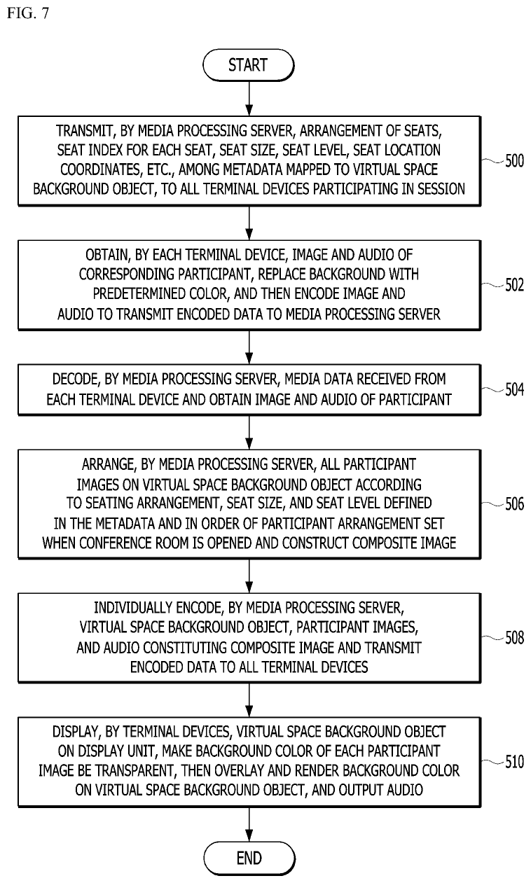

FIG. 7 is a flowchart illustrating an embodiment of a process in which a high-immersion conference mode video conference is executed.

First, the media processing server 130 transmits metadata such as arrangement of seats, a seat index for each seat, a seat size (i.e., participant image size), a seat level, and seat location coordinates, among the metadata mapped to the virtual space background object selected by the host terminal device 10n as described above, to all the terminal devices 10a to 10n participating in the corresponding session (operation 500).

Subsequently, the camera control unit 32 of each of the terminal devices 10a to 10n controls the camera to obtain an image of the corresponding participant. The video preprocessing unit 34 of each of the terminal devices 10a to 10n removes the user background from the corresponding participant image, replaces the background with a random color, and then adjusts the size of the participant image to match an image size determined for the corresponding participant. To remove the user background, a three-dimensional (3D) depth camera using an infrared (IR) sensor may be used, or an open machine learning library or other technologies may be used. The video encoder/decoder 36 of each of the terminal devices 10a to 10n encodes the pre-processed participant image, and the audio encoder/decoder 38 encodes audio acquired through the microphone. Each of the terminal devices 10a to 10n transmits media data including the encoded video data and the encoded audio data to the media processing server 130 (operation 502).

The media processing server 130 decodes the media data received from each of the terminal devices 10a to 10n and obtains the participant image of the corresponding terminal device (operation 504). Subsequently, the layout control unit 212 of the media processing server 130 arranges all the participant images on the selected virtual space background object according to the seating arrangement, the seat size (i.e., participant image size), and the seat level (host, presenter, very important persons (VIPs), etc.) defined in the metadata mapped to the selected virtual space background object and in the order of participant arrangement set by the conference room opener when the conference room is reserved, and maintains and manages the arrangement regardless of the participants entering or exiting the conference room. The media mixing unit 220 of the media processing server 130 constructs a composite image combining the virtual space background object and the participant images according to the arrangement (operation 506).

Next, the composite media post-processing unit 222 of the media processing server 130 may individually encode image elements constituting the composite image, that is, the virtual space background object, the participant images, and the audio. In this case, the multimedia encoding unit 224 of the media processing server 130 may encode the composite media with multiple qualities so that each of the terminal devices 10a to 10n can receive an optimal media stream. The media data transmission/reception unit 226 of the media processing server 130 transmits the encoded composite media stream to all the terminal devices 10a to 10n managed by the session object management unit 200 (operation 508).

Meanwhile, when the seat arrangement order or seat level is not specially set for each participant when a conference is opened, the participant images may be laid out on the virtual space background object in the order in which the participant images are first received from the terminal devices 10a to 10n or in the order of entry and according to the seat arrangement and seat size defined in the metadata.

The terminal devices 10a to 10n that receive the composite media stream from the media processing server 130 display the virtual space background object on a display unit, make the background color of each decoded participant image be transparent, and then overlay and render the background color on the virtual space background object. In addition, the terminal devices 10a to 10n may output the decoded audio through a speaker (operation 510). In this way, the participant images are overlaid and rendered on the virtual space background object in the size defined by the metadata and in a predefined order, and thus it is possible to construct a highly immersive conference image.

Meanwhile, the virtual space background object may be configured to cause an event. Here, the event may be referred to as a selective state change for some of the components of the virtual space background object. Examples of the event include changing lighting conditions in a virtual space background, pulling or closing curtains, posting shared data in the background, enlarging shared data, switching presenter-centered screen, etc. According to an exemplary embodiment, the event may be processed through interaction between the media processing server 130 and the terminal devices 10a to 10n during the session (operation 512).

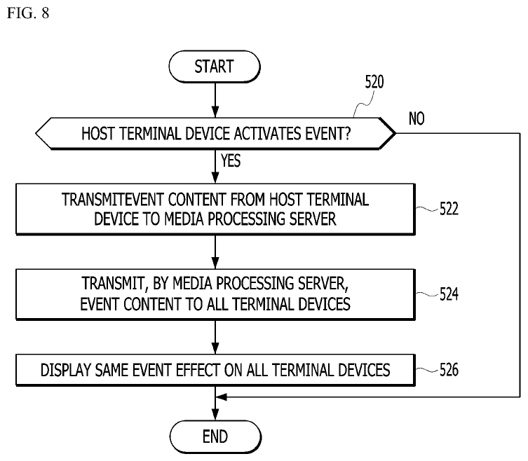

FIG. 8 is a flowchart illustrating an embodiment of a process in which an event is processed. An event may be activated by the host terminal device 10n. When the host terminal device 10n activates an event (operation 520), the content of the corresponding event is transmitted to the media processing server 130 (operation 522). The shared data relay unit 230 of the media processing server 130 may transmit the content of the event to all the terminal devices 10a to 10n participating in the corresponding session (operation 524) so that the same event effect may be displayed on all the terminal devices 10a to 10n (operation 526).

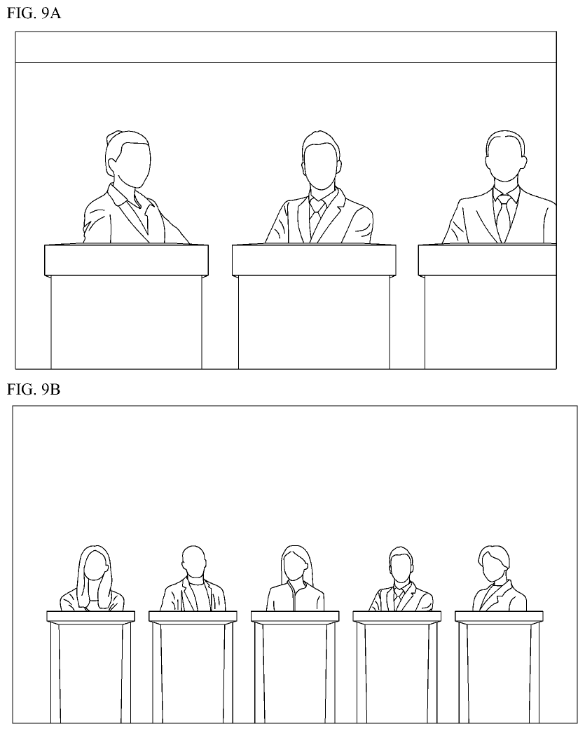

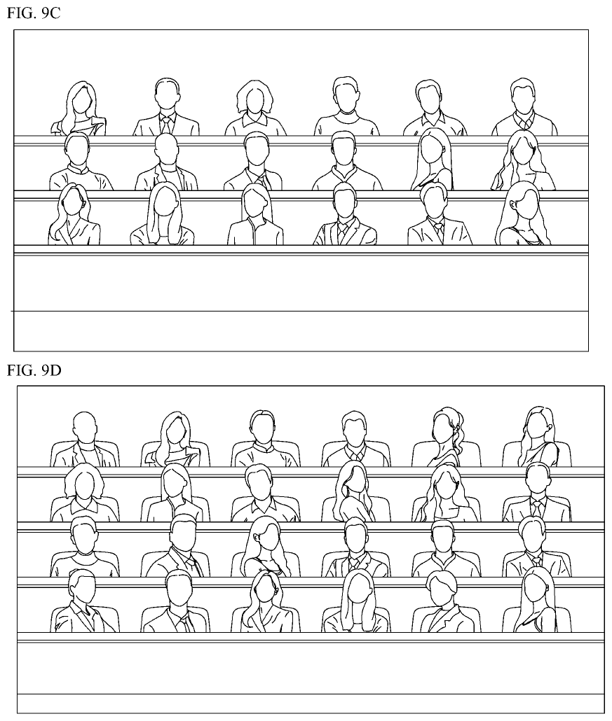

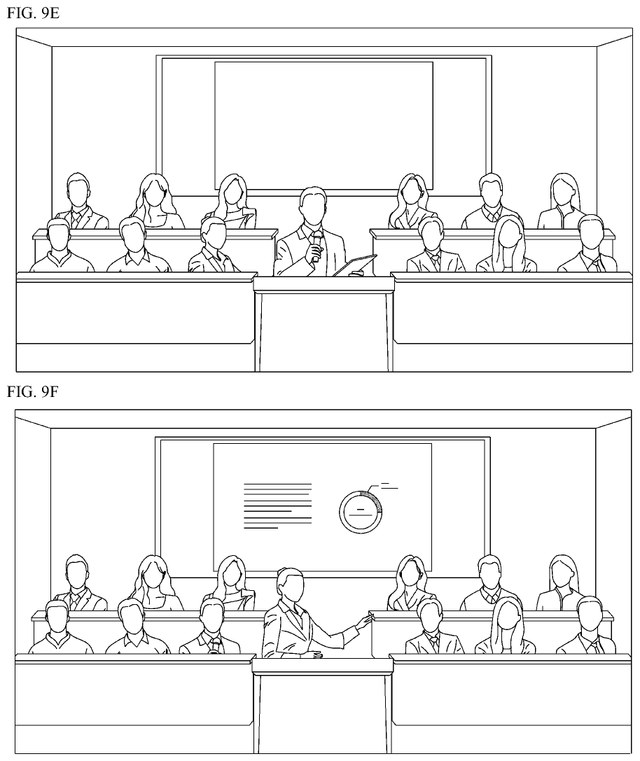

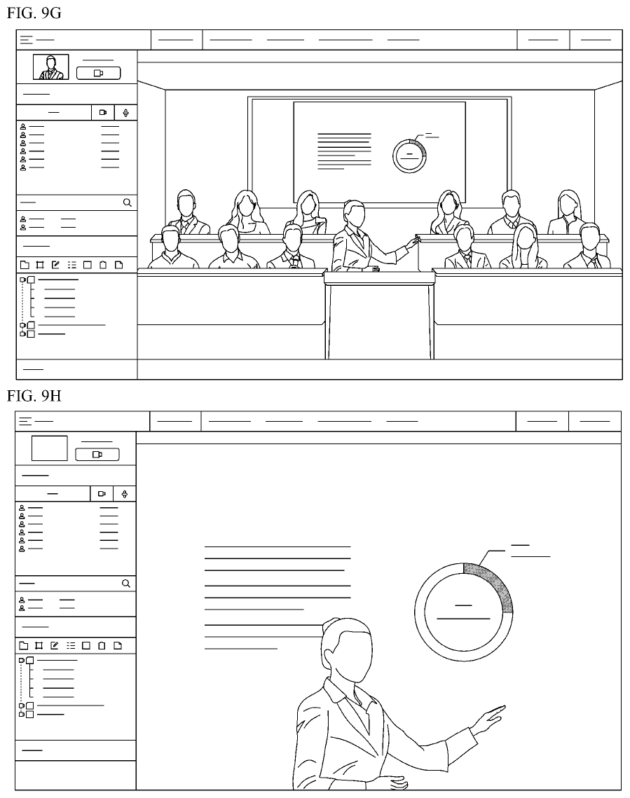

FIGS. 9A to 9H show video conference images generated by overlaying participant images on virtual space background objects.

FIG. 9A shows an example in which participant images are composited and displayed on a three-person panel-type virtual space background object. FIG. 9B shows an example in which participant images are composited and displayed on a five-person panel-type virtual space background object. FIG. 9C shows an example in which participant images are composited and displayed on a six-person chaise lounge grid-type virtual space background object. FIG. 9D shows an example in which participant images are composited and displayed on a personal chaise grid-type virtual space background object. FIG. 9E shows an example in which participant images are composited and displayed on a grid-type virtual space background object with a presenter/host podium. FIG. 9F shows an example in which a presenter or host is located on a podium in a virtual space background and an event posting shared data in the background is overlaid and displayed. In this case, the presenter may be introduced by the host.

FIG. 9G is a screenshot showing an example of a screen in which a composite image of FIG. 9F is applied to a video conference. In this example, the entire list of conference participants, the host and presenter, and the list of data/content to be shared may be displayed on the left side of the screen, and the composite image may be displayed on the right side of the screen. FIG. 9H shows an example in which a presentation material is expanded as an event on the screen of FIG. 9G and the presenter is displayed on the presentation material.

Group communication in high-immersion conference mode may end when a predetermined termination event occurs. An example of an end event may include the arrival of a conference end time set when the conference has been opened. That is, when the opener sets the conference end time when the conference has been opened, group communication may automatically end when the end time arrives. Another example of the termination event may include input of a termination declaration or termination command by the host terminal device 10n. That is, when the host selects, for example, an end button on the conference screen or settings screen, an end command may be transmitted to the terminal devices 10a to 10n through the media processing server 130 and the group communication may end.

According to the group communication system according to the embodiments of the present invention described above, multiple geographically distributed terminal devices may stably perform highly immersive group communication on the same virtual space background object, regardless of the type of terminal devices. The group communication using virtual space background object according to the embodiments of the present invention may be used in various fields such as two-way distance education, two-way events, entertainment requiring non-face-to-face broadcasting, two-way seminar broadcasting, two-way home shopping, and the like.

The system and method according to the embodiments of the present invention may be implemented as computer-readable programs or code on computer-readable recording media. The computer-readable recording media include all types of recording devices in which data that can be read by a computer system is stored. Further, the computer-readable recording media may be distributed across computer systems connected through a network so that computer-readable programs or code may be stored and executed in a distributed manner.

Although some aspects of the present invention have been described in the context of the device, it may also refer to a corresponding method description, where a block or device corresponds to an operation of a method or features of the operation of the method. Similarly, aspects described in the context of the method may also be represented by corresponding blocks or items or features of a corresponding device. Some or all of the operations of the method may be performed by (or using), for example, a hardware device such as a microprocessor, a programmable computer, or an electronic circuit. In some embodiments, one or more of the most important operations of the method may be performed by such a device.

According to exemplary embodiments of the present invention, in arranging images of participants in a group communication conference on a virtual space image, a conference room opener or host can set an image size and seating arrangement in a form optimized for virtual space image composition. When participants enter, video size determination and seat arrangement can be performed automatically according to settings. Accordingly, there is no need for the conference room opener or host to spend a lot of time and perform an additional action of manually rearranging participants in a virtual space, the opener or host can rapidly start a conference, and two-way communication-based video conferencing with high immersion and concentration is possible.

In particular, in a conference room constructed similar to the real world, each participant's seat can be determined in advance by a conference room opener in consideration of protocol, and thus regardless of the order in which each participant enters the conference room and even when each participants leave midway and re-enter, it is possible to prevent the seating arrangement of participants from becoming random and to pay attention to movements of specific participants, such as VIPs, such as their positions and remarks. Therefore, the participants' sense of immersion and concentration can further increase, and the satisfaction of important participants involved in the protocol can be significantly increased. Even when there are special seats for the presenter and/or host, the seating arrangement is determined to reflect the special seats, and no manual adjustment is required for the arrangement of the presenter and/or host seats.

Events related to conference room settings or changing the settings during the conference that is performed in advance, or events related to additional conditions such as lighting can be shared with participants. Further, when it is necessary to adjust the size of the image to be arranged on a specific seat, a video size adjustment request containing required image size information can be immediately transmitted to the corresponding terminal device, and thus the corresponding terminal device can transmit the image in the corresponding size. In addition, the seat and the participant images arranged within the virtual space are arranged in consideration of perspective. Due to such dynamic setting changes and user interfaces, according to the exemplary embodiments of the present invention, in group communication involving a plurality of geographically distributed access terminal devices, the sense of presence perceived by participants can be increased, and each participant's level of immersion in the remarks of other participants can be increased.

Content displayed as a virtual space background can include not only simple images but also various objects such as videos, auxiliary camera videos, screen sharing videos, documents, etc., and thus immersion can be further increased. Furthermore, objects constituting a virtual space background can include events whose composition is changed depending on the selection of the conference room opener or host, and, in this case, all participants can share the event to conduct immersive group communication in a more realistic virtual space as background.

Since the present invention allows multiple terminal devices to immediately receive stable services through a high-immersion screen while maintaining quality appropriate for their resources, the present invention can be applied to various fields such as two-way immersive distance education tailored to the terminal resource situation, two-way events, non-face-to-face entertainment that requires two-way broadcasting, seminar broadcasting, two-way home shopping, and the like.

Further, since terminal devices that have used traditional video conferencing systems based on standard protocols such as Session Initiation Protocol (SIP) can also participate in the virtual space-based and object-based high-immersion group communication of the present invention through signal gateways and media gateways, already invested assets can be recycled.

The video conference group communication method of the present invention is applicable to both selective forwarding unit (SFU) and multipoint control unit (MCU) type video conference systems.

While the example embodiments of the present invention and their advantages have been described above in detail, it should be understood by those skilled in the art that various changes, substitutions and alterations may be made herein without departing from the scope of the invention as defined by the following claims.

What is claimed is:

1. A video conference support method, which is performed by a group communication server to which multiple participants are able to be connected using their own terminal devices, comprising:
presenting a plurality of virtual space background objects, each of which is associated with seat arrangement and metadata representing seat information including a seat size, a seat level, and seat location coordinates for each seat, to a host terminal device through a network, and receiving information on a selected virtual space background object from the host terminal device;
obtaining participant images each from the multiple terminal devices;
constructing a composite image by arranging all the participant images on the selected virtual space background object according to the metadata and in a predetermined participant arrangement order; and
encoding the selected virtual space background object constituting the composite image, and the participant images and audio, transmitting encoded data to the plurality of terminal devices, and causing the terminal devices to overlay and output the participant images on the selected virtual space background object.

2. The method of claim 1, further comprising, before performing the presenting of the plurality of virtual space background objects to the host terminal device through the network and the receiving of the information on the selected virtual space background object from the host terminal device, receiving a request to proceed with a high-immersion conference mode from a predetermined conference host terminal device.

3. The method of claim 2, further comprising receiving and determining the participant arrangement order from the conference host terminal device after receiving the request to proceed with the high-immersion conference mode.

4. The method of claim 1, wherein, in the encoding of the selected virtual space background object, the participant images, and the audio and the transmitting of the encoded data to the plurality of terminal devices, the selected virtual space background object, the participant images, and the audio are individually encoded and the encoded data is transmitted to the plurality of terminal devices.

5. The method of claim 1, wherein each of the plurality of virtual space background objects includes a plurality of seats where a seat size and a displayable user image size are determined differently in perspective.

6. The method of claim 1, wherein the selected virtual space background object includes an event element that is able to selectively cause a state change, and
the encoding of the selected virtual space background object, the participant images and the audio and the transmitting of the encoded data to the plurality of terminal devices includes transmitting the content of the state change of the event element to the plurality of terminal devices so that the terminal devices reflect the state change of the event element on the selected virtual space background object.

7. A group communication support device that allows multiple participants to conduct a video conference using their own terminal devices, comprising:
a memory configured to store program instructions; and
a processor that is connected to the memory and executes the program instructions stored in the memory,
wherein, when the program instructions are executed by the processor, the program instructions allow the processor to:
present a plurality of virtual space background objects, each of which is associated with seat arrangement and metadata representing seat information including a seat size, a seat level, and seat location coordinates for each seat, to a host terminal device through a network, and receive information on a selected virtual space background object from the host terminal device;
obtain participant images each from the plurality of terminal devices;
construct a composite image by arranging all the participant images on the selected virtual space background object according to the metadata and in a predetermined participant arrangement order; and
encode the selected virtual space background object constituting the composite image, and the participant images and audio, transmit encoded data to the plurality of terminal devices, and cause the terminal devices to overlay and output the participant images on the selected virtual space background object.

8. The device of claim 7, wherein the program instructions include instructions for causing the processor to receive a request to proceed with a high-immersion conference mode from a predetermined conference host terminal device before presenting the plurality of virtual space background objects to the host terminal device through the network.

9. The device of claim 8, wherein the program instructions further include instructions for causing the processor to receive and determine the participant arrangement order from the conference host terminal device after receiving the request to proceed with the high-immersion conference mode.

10. The device of claim 7, wherein the program instructions cause the processor to individually encode the selected virtual space background object, the participant images, and the audio and transmit the encoded data to the plurality of terminal devices.

11. The device of claim 7, wherein each of the plurality of virtual space background objects includes a plurality of seats where a seat size and a displayable user image size are determined differently in perspective.

12. The device of claim 7, wherein the selected virtual space background object includes an event element that is able to selectively cause a state change, and
the program instructions for causing the processor to encode the selected virtual space background object, the participant images and the audio and transmit the encoded data to the plurality of terminal devices include instructions for transmitting the content of the state change of the event element to the plurality of terminal devices so that the terminal devices reflect the state change of the event element on the selected virtual space background object.

13. A video conference setting and executing method, which is a method for a conference host terminal device to set and execute a video conference conducted by a group communication server to which multiple participants are able to be connected using their own terminal devices, comprising:
transmitting a request to proceed with a high-immersion conference mode to the group communication server;
receiving a plurality of virtual space background objects, each of which is associated with seat arrangement and metadata representing seat information including a seat size, a seat level, and seat location coordinates for each seat, from the group communication server through a network, and transmitting information on a virtual space background object selected by a host;
obtaining and encoding an image and audio of the participant from the conference host terminal device using a camera and microphone and transmitting the encoded images and audio to the group communication server;
receiving the selected virtual space background object, multiple participant images, and composite audio from the group communication server; and
overlaying and outputting the participant images on the selected virtual space background object.

14. The method of claim 13, wherein the selected virtual space background object includes an event element that is able to selectively cause a state change, and
the receiving of the selected virtual space background object, the multiple participant images, and composite audio from the group communication server or the overlaying and outputting of the participant images on the selected virtual space background object includes reflecting the state change of the event element on the selected virtual space background object.
